(19) United States
(12) Patent Application Publication
(10) Pub. No.: US 2007/0143503 A1
(43) Pub. Date: Jun. 21, 2007

(54) System and method for exchanging data between computing devices

(76) Inventors: Parag Gupta, San Jose, CA (US); Hesham Elbatouti, San Jose, CA (US)

Correspondence Address: SHEMWELL MAHAMEDI LLP, 4880 STEVENS CREEK BOULEVARD, SUITE 201, SAN JOSE, CA, 95129, US

(21) Appl. No.: 11/316,405

(22) Filed: Dec. 21, 2005

(51) Int. Cl. G06F 3/00

(52) U.S. Cl. 710/6

(57) ABSTRACT

Communications may be exchanged between two computing devices for purpose of establishing a collection of data items on one of the devices. During the communication, a data transfer configuration may also be communicated to the device on which the collection of data items is established. When that device communicates with another computing device (“downstream device”), the data transfer process causes the automatic selection of certain data items, either for transfer to the downstream device to the exclusion of other data items in the collection, or for priority of transfer over some or all other data items in the collection.

### TECHNICAL FIELD

The disclosed embodiments relate generally to the field of exchanging data, and more particularly, to a method and system for exchanging data between multiple computing devices.

Communication devices have evolved to include numerous types of communication capabilities and functionality. For example, handheld devices exist that operate as cellular phones, messaging terminals, and Internet devices, while at the same time, including personal information management (PIM) software and photo-management applications. Consumer-friendly computing technology as also been incorporated into numerous mobile mediums, such as watches and automobiles.

With diversification of such devices, the advancement of data transfer between devices has also expanded. Now, users can employ a wide variety of transport mechanisms, including infrared, wireless fidelity (WiFi), Bluetooth, cellular, and wireline connections, to transfer data amongst devices. Further, the type of data being transferred has also become more diverse. Users can now transfer records, files (e.g. media files) and documents amongst devices using one of the various transport mechanisms.

Different levels of sophistication and intelligence exist amongst devices in how records and files are utilized. While one device may enable a user to be selective, another device may act “dumb” and offer little user control. For example, telephony automobile kits exist that can carry contact records for speed-dial and lookup purposes. Such kits often have limited memory or size, so that the user can carry only an abridged version of his overall contact library.

### BRIEF DESCRIPTION OF THE DRAWINGS

FIG. 1 illustrate a system for exchanging data between a series of computing devices, in which configurations specified at an initial transfer affect a downstream transfer of data, under an embodiment of the invention.

FIG. 2 illustrates a process flow diagram for transferring data amongst different computing devices, under an embodiment of the invention.

FIG. 3 illustrates a method for communicating data transfer configurations amongst computing devices, according to an embodiment of the invention

FIG. 4 illustrates a basic method for transferring records, under an embodiment of the invention.

FIG. 5 illustrates a more specific embodiment in which contact records are transferred downstream for telephony purposes

FIG. 6 illustrates an example of a system in which one or more embodiments of the invention may be implemented.

FIG. 7 is a basic block diagram of a computing device for handling data transfer configurations, for use in performing one or more embodiments of the invention.

### DETAILED DESCRIPTION

According to one or more embodiments, data may be exchanged between a series of computing devices, where the data transfer between a first pair of computing devices also includes data that configures subsequent transfers between the recipient of that pair and other computing devices. In particular, one embodiment enables a user to establish downstream data transfer configurations for data items that are then transferred to a recipient device. The downstream data configurations may then control, influence, or otherwise prioritize select data items in the collection over other data items when a transfer is initiated from the recipient device to a third device.

In one embodiment, the data transfer configurations cause selection of specific data items to the exclusion of other data items for transfer from the recipient device to a third device. In another embodiment, the data transfer configurations specify a priority, where select data items are to be transferred with higher priority (e.g. before in time) than other data items in the collection.

Embodiments described herein may be used in various context and systems. In one embodiment, a portable computing device receives the data transfer configurations. The portable computing device may correspond to any small-form factor device, such as a cellular communication device (“smart phone” or multi-functional device with cellular telephony capabilities), a personal digital assistant, a digital camera, a portable music player (e.g. “MP3 player”) or other device. In such an embodiment, the downstream device may correspond to a device with limited capabilities of enabling a user to receive the benefit of all the data items in the collection.

In one embodiment, a data transfer configuration is identified on a first computing device, where the identified data transfer configuration is to be used in a subsequent data transfer between a second computing device and a third computing device. The data transfer configuration causes selection of data items from a larger collection of data items that are to be exchanged in the subsequent data transfer. The data transfer configuration may be automatically implemented on the second computing device as a result of the first computing device communicating with the second computing device.

According to another embodiment, communications may be exchanged between two computing devices for purpose of establishing a collection of data items on one of the devices. During the communication, a data transfer configuration may also be communicated to the device on which the collection of data items is established. When that device communicates with another computing device (“downstream device”), the data transfer process causes the automatic selection of certain data items, either for transfer to the downstream device to the exclusion of other data items in the collection, or for priority of transfer over some or all other data items in the collection.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

Additionally, one or more embodiments described herein may be implemented using modules. A module may include a program, a subroutine, a portion of a program, or a software component or a hardware component capable of performing one or more stated tasks or functions. As used herein, a module can exist on a hardware component independently of other modules, or a module can be a shared element or process of other modules, programs or machines.

Furthermore, one or more embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums.

System Overview

FIG. 1 illustrate a system for exchanging data between a series of computing devices, in which configurations specified at an initial transfer affect a downstream transfer of data, under an embodiment of the invention. In FIG. 1, a system includes a first computing device 110, a second computing device 120, and the third computing device 130. In an example provided by FIG. 1, a data transfer is performed between the first computing device 110 and the second computing device 120, and then between the second computing device 120 and the third computing device 130. As will be described, data transferred when the first and second computing devices 110, 120 are in communication may determine some or all of the data transferred downstream, such as between second and third computing devices 120, 130, or between third and fourth computing devices. In one embodiment, the communication exchange between the first and second computing devices 110, 120 may designate, select, or enable the selection of data exchanged between the second and third computing devices 120, 130 respectively.

At an initial time, a data transfer process may be executed on one or both of the first computing device 110 and the second computing device 120. In an embodiment shown, data transferred between the first and second computing devices 110, 120 is through a synchronization process, or other data exchange mechanisms by which processes are executed on both computing devices to enable the transfer of data. Accordingly, a first data transfer process 112 is executed on the first computing device 110, and a second data transfer process 122 is executed on the second computing device 120. The first and second data transfer processes 112, 122 may cause the transfer of data corresponding to the collection of data items (“collection data 125”). The transfer of collection data 125 may establish a collection of data items 126 on the second computing device 120. To this end, collection data 125 may correspond to all data items in the collection, or alternatively some data items that are combined with existing data items on the second computing device 120 to establish the collection 126. Still further, the collection data 125 may correspond to update data of specific data items in the collection 126. Thus, collection data 125 may transfer some or all data items in the collection, or simply update or compliment data items already existing on the second computing device 120.

As an example, in a first instance, the data transfer may be complete, in that all data items in the collection are transferred from the first computing device 110 to the second computing device 120. On subsequent instances, the transfer may take the form of updating, such as by sending data that updates or compliments existing data on the second computing device 120. In an embodiment such as described with FIG. 1, an example of data items that can be transferred amongst computing devices such as shown include one or more of records, files and documents. Specific examples include contact or telephone records, emails and other messages, picture files, audio files (such as for playing music) or electronic notes or memorandums.

In addition to the collection data 125, first computing device 110 may communicate configuration data 127 for one or more subsequent downstream data transfers between other computing devices. In one embodiment, configuration data 127 is communicated with collection data 125. Thus, for example, configuration data 127 and collection data 125 may be communicated from the first computing device 110 to the second computing device 120 during a synchronization process in which the collection 126 is being updated or created. On the second computing device 120, the establishment of data items in the collection 126 coincides with the receipt of configuration data 127.

Alternatively, the configuration data 127 may be provided independently of any data transfer process involving collection data 125. For example, the configuration data 127 may be transferred separately from the collection data 125.

On second computing device 120, the configuration data 127 received through the data transfer process 122 is implemented as data transfer configurations 137 that select data items from the collection 126. Data transfer configurations 137 may correspond to programmatically generated signals or processes that convert configuration data 127 into programmatic actions. The data transfer actions 137 may be created either by the data transfer process 122, or another program or programmatic resource. The data transfer configurations 137 may be used by a subsequent data transfer process 128 to cause the selection of some or all data items that are to be transferred or otherwise communicated between the second computing device 120 and the third computing device 130. In an embodiment such as shown, the configuration data 127 may communicate designations (e.g., folder designation), parameters, metadata, or conditions and criteria. When implemented, the data transfer configurations 137 may select data items from the collection 126 by marking which data items in the collection should be transferred to the third computing device 130. For example, parameters, metadata and other data indicating designations of data items made on the first computing device 110 may be translated into designations on the second computing device 120. Under another implementation, criteria or conditions set forth as configuration data 127 may be executed to identify select data items that should be prioritized for transfer from the second computing device 120.

The following are specific examples of how configuration data 127 may be implemented to select data items from the collection 126 for priority transfer to the third computing device 130.

In one embodiment, priority designation is provided for all contact items in a designated folder at the time of transfer from the first computing device 110 to the second computing device 120. Configuration data 127 may then correspond to parameters or metadata that identify what data items in the collection have correspondence to items on the first computing device 110 that are in the designated folder. All data items in the collection 126 that correspond to data items of the designated folder in the first computing device are then prioritized for transfer to the third computing device 130. As another example, the first and second computing device 110, 120 may be connected so that a view is presented on the first computing device that shows contents of the second computing device. The user may enter information that relates to or corresponds to the data transfer configurations on the first computing device, even though the data is entered when the two computing devices are in active communication, and the first computing device is providing an active view of the second computing device. In this scenario, the configuration data may be entered on the first computing device 110, but communicated immediately to the second computing device 120.

In another example, the data items may correspond to contact records, and the configuration data 127 is a condition or criteria that specifies the most-used contact record or records, or the most recently used contact record or records. Contact records are records that carry information about a person, and in particular, information for contacting or communicating with a person. Example of information that can be carried in a contact record includes phone numbers, email addresses, messaging identifiers for other types of messages (e.g. instant messages, Short Message Service messages), as well as name, address, and other information about a person. When implemented, a programmatic process may be performed to identify contact records that match the condition or criteria. For example, all contact records appearing in a most recently dialed list may be marked on the second computing device 120 for priority transfer to the third computing device 130.

In one embodiment, the data transfer process 128 initiated from the second computing device 128 is unidirectional, meaning it writes onto the third computing device 130. The data transfer process 128 may communicate select data items 135, so as to establish a set of select data items 136 on the third computing device 130. Depending on the implementation or circumstance, the set of select data items 136 may be established through a write, update and/or synchronization process. However, another embodiment may employ more intelligent data transfer processes between the second and third computing devices 120, 130, such as a synchronization process.

With reference to an embodiment of such as shown by FIG. 1, one result that can be achieved is that the data items transferred between the second and third computing devices 120, 130 are the results of filtering actions performed on the first computing device 110. For example, the user-input on the first computing device 110, and/or at the time that data is transferred between the first computing device and the second computing device 120, may cause selection of specific data items for downstream data transfers. In this way, the user may rely on the capabilities and functionality of the first computing device 110 to determine what data items should be transferred in the communications between the second and third computing devices 120, 130. The capabilities and functionality of the first computing device 110 may provide ease of use, such as a full-sized keyboard and display, while the second computing device 120 may be of small form factor and more difficult to use and specify the data transfer configurations 137. In addition to convenience, a situation may exist where the originating computing device is a “master store” of all data items that are to be transferred downstream. As such, the originating computing device may provide a master store of all the data items, and the user may be able to better control and manage the transfer of documents downstream as a result of entering data transfer configurations on that particular device. As an alternative or addition, the user may specify what data items are to be transferred or exchanged downstream prior to only one data transfer process, so that any effect of the data transfer configurations is a one-time event.

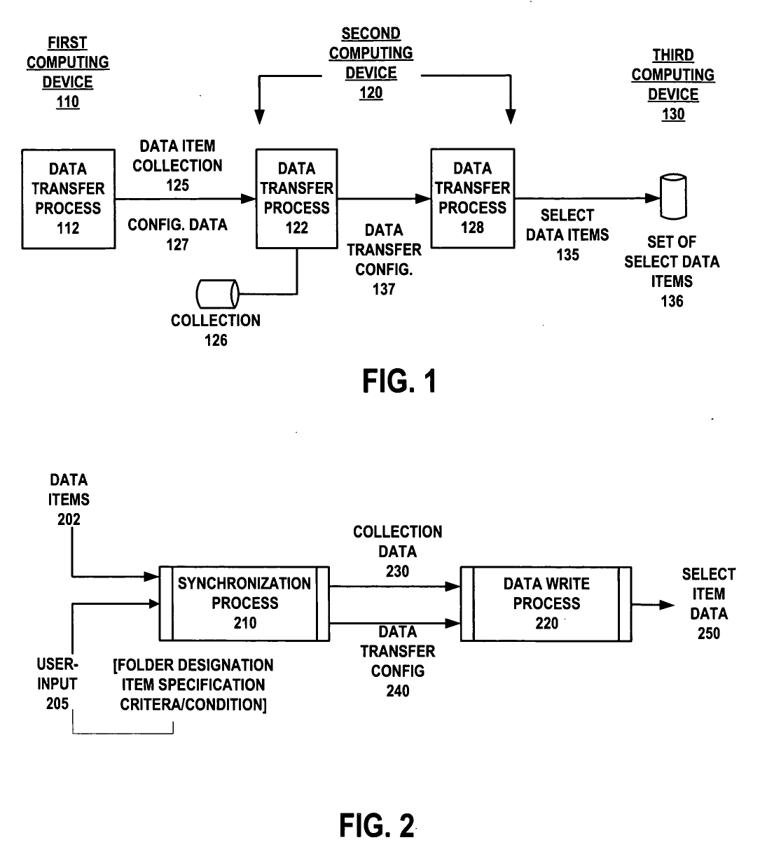

FIG. 2 illustrates a process flow diagram for transferring data, under an embodiment of the invention. In an embodiment shown, two data transfer processes are described: a synchronization process 210 and a data write process 220. In one implementation, synchronization process 210 may be implemented between a pair of computers. As will be described, the synchronization process 210 may specify a data transfer configuration 240 that determines some or all data transferred in the subsequent data write process 220.

The data write process 220 may be implemented between one of the computing devices of the first pair and another computing device. In one implementation, the synchronization process 210 may be implemented between a fully functional computer (e.g. desktop or laptop computer) and a small form-factor, communicative device (e.g. a smart phone or personal digital assistant. The data write process 220 may be performed between the second computing device and a limited functional computer, such as an automobile kit or wristwatch computing device. In such an implementation, an embodiment enables the user to utilize the greater functionality of the first computing device to specify a filter or other configuration for the data transfer between the second and third computing devices.

Different kinds of synchronization processes exits. Synchronization processes 210 may correspond to a unidirectional or bidirectional process. For example, in a unidirectional synchronization process, a source computer (e.g. first computing device 110) may transfer data items that have not already been provided to a recipient computer (e.g. second computing device 120), or alternatively, transfer data for updating data items that have been previously provided. but updated. In a bidirectional synchronization process, both computers involved in the transfer may receive or have data items updated by the other computer. In the data write process 220, the source computer (e.g. the second computing device 220) simply writes data items to the recipient (e.g. third computing device) without regard to existing data on that device.

While an embodiment shown by FIG. 2 shows a specific sequence of the use of synchronization process 210 and the data write process 220, other embodiments may employ only data write processes, only synchronization process, or a data write process followed by a synchronization process. Thus, numerous variations or possible to an embodiment such as shown by FIG. 2.

In an embodiment shown, the synchronization process 210 employs data items 202 and user-input 205. Data items 202 may correspond to records, files, documents and resources that are synchronized. This means that after the synchronization process 210 is performed, the first computing device 110 (FIG. 1) and the second computing device 120 (FIG. 1) may have duplicate sets of synchronized folders. As a result of the synchronization process 210, the recipient computer may be provided an updated collection of data items. Further, as another result of the synchronization process 210, the recipient computer may include data transfer configurations 240.

The data write process 220 may use as input the collection data 230, representing individual data items in the collection, and the data transfer configurations 240. Data transfer configurations 240 may serve as designations, metadata, criteria, or even programmatic elements that cause selection of specific data items from the collection. An output of the data write process is select data items 250, which is derived from the collection, using the data transfer configurations 240.

In one implementation, the collection includes contact records of a user. Select data items 250 correspond to select of contact records, such as contact records that the user has previously designated in a separate folder on the source computer of the synchronization process 210. As another example, media files, such as songs or other audio files, may be transferred in addition to or instead of contact records.

Methodologies for Configuring Downstream Data Transfer

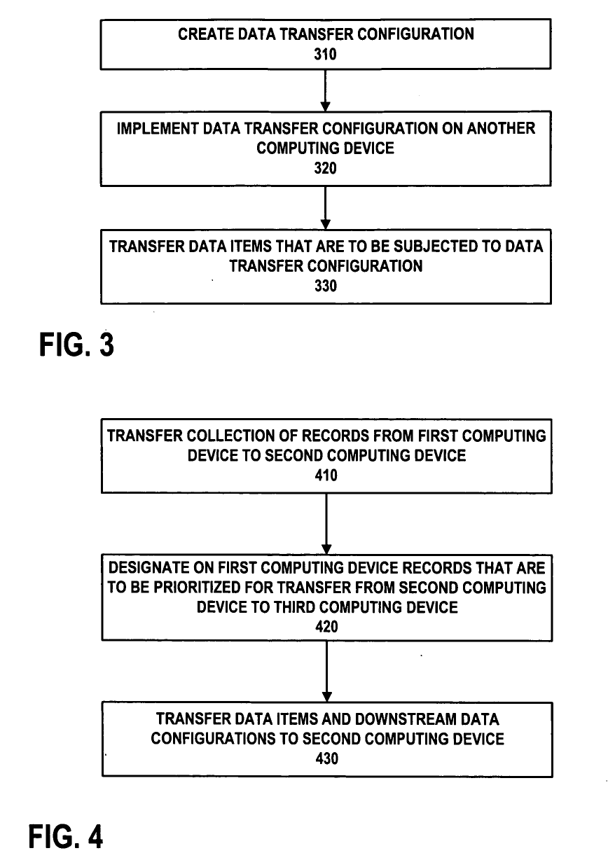

FIG. 3 to FIG. 5 illustrate different embodiments by which data transfer between two computing devices can be used to implement controls and/or configurations for subsequent downstream data transfers of those same data items with other computing devices. In particular, FIG. 3 to FIG. 5 describe methods by which such controls and configurations can be implemented on downstream data transfers, according to one or more embodiments of the invention. With regard to each method described, reference may be made to other elements or components of other embodiments for purpose of illustrating suitable components for performing a step or sub-step being recited.

In FIG. 3, a method is described for communicating data transfer configurations, according to an embodiment of the invention. In step 310, a data transfer configuration is created. The configuration created may influence downstream transfers by prioritizing what records are transferred. For example, as a result of receiving the configuration, the recipient device knows to transfer specific data items to one or more other computing devices over other data items, or before such other data items. As another variation, the configurations may serve to control the one or more downstream data transfers. Specifically, the computing device on which the configuration is created may control downstream configuration of the computing device that receives the configuration by disabling that recipient device from performing transfers of data items that are selected or unselected by the configurations, or alternatively by disabling the recipient device from performing such transfers under specific conditions.

The data transfer configuration may be created in any one of various forms, such as, for example: (i) folder designation (e.g. “Transfer Folder”), (ii) item-by-item designation (e.g. a use checks off each item he wants to transfer), (iii) conditions or criteria (“most recently used data item”), and (iv) a transfer protocol for a particular computing device. With regard to (iii) and (iv), a programmatic component may reside on the recipient device of the first data transfer to implement the condition or criteria, or protocol. The programmatic component may originate from various sources. For example, the programmatic component may be downloaded from the computing device on which the configurations or control were created. A transfer protocol specified by the configurations may be any data, code, or instruction that alters the manner in which the recipient device was to perform downstream data transfers for data items received from the originating computing device. For example, the configuration data created in this step may correspond to data that alters the normal protocol of the recipient device. Where, for example, records were to be transferred alphabetically under the protocol, the configuration data may specify that select records are to be transferred before other records.

In step 320, the data transfer configurations created on the originating device are then implemented on the recipient device. In one embodiment, data corresponding to the data transfer configurations are transferred to the recipient device, then processed so as to identify what data items from a designated collection on the recipient device are to be transferable to another computing device. For example, configurations created in the previous step may be used to select data items on the recipient device that have correspondence to other data items residing on the originating computing device that are designated by the parameters and/or metadata received in the transfer.

An embodiment also provides for the selection or determination of data items that are to be transferable to be determinable only after specific events, or alternatively just before the transfer to the next computing device is to be initiated. For example, the configurations created in the preceding step may be in the form of conditions or criteria, which are satisfied and determinable of selected data items only after a duration of time, or just before initiation of data transfer to the next computing device.

In step 330, data items are transferred to the next computing device, subject to data transfer configurations specified in step 310, and as implemented in step 320. In one embodiment, step 310 is performed in association or connection with a process that establishes a library or collection of data items. Once implemented, the data transfer configurations enable prioritization, selection and/or control of what data items from the collection are transferred to the next computing device. In an implementation where the data transfer configurations specify priority, the order or protocol in which data items is transferred may be altered or influenced, to ensure, for example, that some data items are transferred. The data transfer configuration may also be selective or determinative as to what data items are actually transferred over.

FIG. 4 illustrates a basic method for transferring records, under an embodiment of the invention. A record may correspond to, for example, a table or database entry, such as a contact or phone record. In step 410, a collection of records may be transferred from a first computing device to a second computing device. An example of such a transfer may include a synchronization process, such as one performed between a desktop computer (or laptop or workstation) and a mobile or portable computing device, such as a PDA, cellular telephony device, portable media player (e.g. “MP3 player”), or digital camera. The synchronization process may perform data dumps of the data items in the collection, or updates of specific items, so as to establish and maintain the collection on each device of the synchronization process, or alternatively, on the recipient of the data transfer in the process.

In the example provided, the desktop or other originating computer may have greater capabilities than the recipient computing device. For example, the originating computer may have a full keyboard, a larger display, greater memory resources, better capability for presenting user-interface features (larger graphic user-interface), and better input mechanisms. The greater capabilities may facilitate the user in making selections of data items that are transferable (or conversely not transferable) downstream. For example, the user may be able to specify a folder designation and rapid assignment of records to that folder using a keyboard and mouse combination, while on the smaller recipient device, the process would be much more difficult. To further illustrate an example of convenience provided, using OUTLOOK (manufactured by the MICROSOFT CORPORATION), the user may highlight and select multiple contact records using a few short cut actions, and move these items into a folder. On a small-form factor device, the user may need to open each contact record, and designate the folder, then close the record until all desired records are assigned.

According to an embodiment, step 420 provides that records may be designated on the first computing device for subsequent transfer from the recipient device (downstream transfer). In one embodiment, the designation of records may correspond to a user of the originating computer creating a folder containing items that are designated as having priority transfer from the recipient computer to some other computing device. Records in the folder are then designated.

In step 430, data corresponding to (i) records and (ii) downstream data configurations are transferred to the recipient computing device. Data corresponding to the records are transferred to the recipient computing device so that a collection of records is established on that device. The collection of records may include all the records in the designated folder of the originating computing device, as well as other records maintained as a library or main folder of records for direct transfer to the recipient device. The data corresponding to the downstream data configurations may correspond to metadata, for example, associated with the designated folder created on the originating computer. For example, each record in that folder may be recreated on the recipient computing device, and metadata associated with that record replicates the folder designation on the recipient device.

After transfer between the originating computer and the recipient, the recipient may enable transfer of records with the folder designation, or alternatively prioritize transfer of records in the folder designation over other records that comprise the collection.

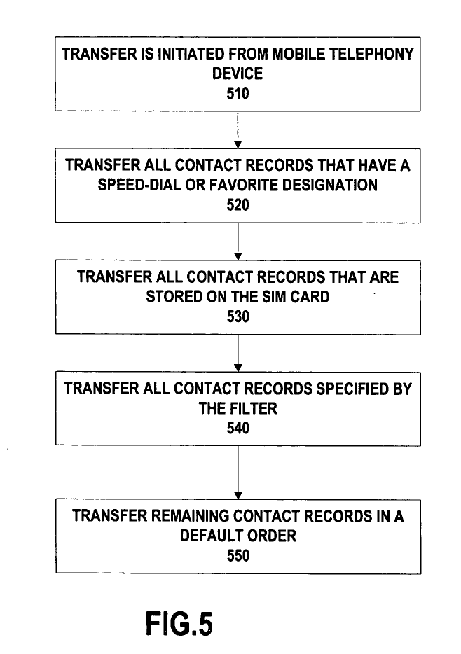

FIG. 5 illustrates a more specific embodiment in which contact records are transferred downstream for telephony purposes. A method described with FIG. 5 assumes telephony contact records are established on a mobile computing device (e.g. “smart-phone”) through a process or method such as described in FIG. 4, although other embodiments may provide for establishment of such contact records and configuration and/or designation of what records can be transferred through other means. For example, FIG. 4 may assume that a user transferred all contact records to the mobile computing device through a prior upstream data transfer, and now another transfer is to be initiated between the mobile computing device and a third computing or device. A method such as described with FIG. 5 may also assume that the prior upstream data transfer caused implementation of data transfer configurations between the mobile computing device and the third computing device.

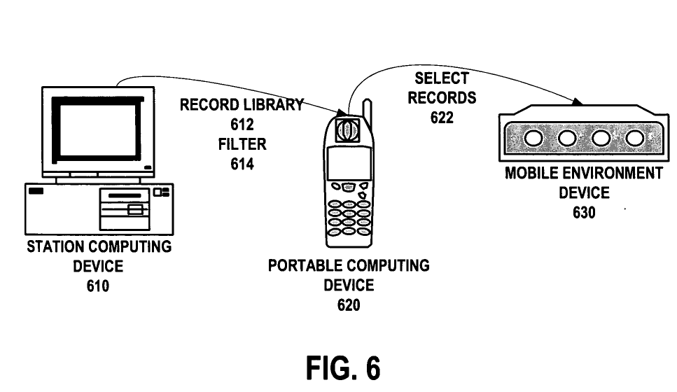

In step 510, a data transfer is initiated from a mobile computing device to another recipient computing device from which telephony operations may be performed or assisted. In one implementation, the recipient device to this data transfer is one with limited ability to carry all the information that could be transferred in this step. Alternatively, the recipient device may be one that has limited ability to enable the user to select or organize contact records or data items. An example of such a scenario is described with FIG. 6. Furthermore, as described with FIG. 2, the data transfer process may be in the form of a write process, or even synchronization if the recipient device has the ability.

According to an embodiment, a protocol exists for transferring records between the two computing devices. The protocol may specify an order or sequence in which specific records are to be transferred. In one implementation, step 520 provides that under the protocol, all contact records that have a speed-dial or favorite designation on the mobile device are transferred first. Alternatives and additional designations are possible. For example, some devices carry a list of most recently used contact records, and this list may be used to identify contact records to be transferred independent of any data transfer configurations.

In step 530, an embodiment provides that all contact records stored on the mobile computing device's Subscriber Identification Module (SIM) card are transferred next. According to an embodiment, both step 520 and step 530 may be performed regardless of the data transfer configurations provided from the upstream data transfer.

Step 540, however, implements the data transfer configurations from the upstream data transfer. In step 540, all contact records specified by the upstream data configuration are transferred to the third computing device. For example, the upstream transfer may have allocated some contact records to a share folder, and this step may cause transfer of contact records identified as belonging to that folder designation. As such, step 540 identifies and selects contact records in a larger collection of contact records established from the upstream data transfer.

In step 550, all remaining contact records that can be accommodated by the third computing device are transferred, using a default or standard sequence. For example, if memory on the third computing device is limited to holding only 50 contact records, and step 520-540 provide only 30 contact records on the computing device, then 20 contact records may be provided from the remainder of the collection. If there are more than 20 contact records, the records selected may be through some default mechanisms, such as alphabetical listing. Thus, if the user's contact library existing on the mobile computing device has, for example, 200 contact records, and the recipient device to the transfer can handle only 50 records, about 150 records may not make the transfer. But at least those contact records designated through transfer configuration data have priority in the transfer. As such, the user has full control of the minimum set of data items that can be transferred.

Usage Scenarios

As mentioned, numerous usage scenarios and implementations are contemplated for use with one or more embodiments described herein. FIG. 6 illustrates one system in which embodiments of the invention may be implemented. In FIG. 6, a system includes a station computing device 610 (e.g. desktop computer, workstation or laptop), a portable computing device 620, and a mobile environment device 630. The mobile environment device 630 may correspond to, for example, a computer in an automobile, or a watch with computational capabilities.

In an example provided, the portable computing device 620 corresponds to a multi-function cellular telephony device, such as one with telephony and messaging capabilities, as well record keeping of data associated with personal information management (PIM) software (e.g. contacts, electronic calendar, memorandums, electronic ink notes). Alternative or additional functionality that can be incorporated into the portable computing device may include image and video capture, video playback, audio/music playback, audio recordation, and gaming. To this extent, the type of data items that can be received from the station device 610 may include records, documents, programs, and files. In a specific example shown by FIG. 6, the computing devices exchange contact records for use in reading and/or selecting phone numbers or individuals to call from a telephony device. The mobile environment device 630 may have similar functionality or need for the data items being transferred amongst the different computing devices. In an example shown, the mobile environment device 630 may correspond to an automobile cellular telephone or telephone kit that can retain contact records and implement programmatic dial functions to facilitate the user when driving.

As described with other embodiments, the station device 610 may transfer a library 612 of contact records to the portable computing device 620. In addition, the station device 610 may transfer a filer 614. The filter 614 may correspond to any data set, parameter, or instruction set that selects or enables selection of individual contact records from the library 612. For example, the filter 614 may correspond to a metadata set that indicates specific contact records on the station device 610 that were placed in a shared folder, or otherwise marked for prioritization in a downstream transfer.

The portable computing device 620 may implement the filter 614 so that in a subsequent data transfer with the mobile environment device 630, select records 622 from the library 612 are either prioritized are transferred to the exclusion of other records. Thus, for example, as shown by FIG. 5, the filter 614 may select a specific set of records to receive priority treatment (e.g. step 540) over other contact records. In one case, the portable computing device 620 has a much greater capacity to hold contact records than the mobile environment device 630, so the step of prioritizing or even selecting what records end up in the last device of the transfer is beneficial to the user. Alternatively, too many records or data items on the mobile environment device 630 may be inconvenient or burdensome if the mobile environment device 630 has limited user-interface capabilities. For example, the mobile environment device 630 may have limited input mechanisms or navigation mechanisms to see stored records, so there may be benefit in reducing the number of records or other items stored on the device to a smaller number.

Numerous transport mechanisms are contemplated for use in transferring data between station device 610 and the portable computing device 620, and between portable computing device 620 and the mobile environment device 630. Specific examples of transport mechanisms that can be used for communications between either pair include: short range wireless, long range wireless, and wireless connections. Short range wireless connections include, for example, Bluetooth, wireless fidelity (WiFi) (e.g. 802.11 standards), and Infrared connectivity. Long range wireless connectivity includes, for example, cellular connectivity (including broadband cellular). Examples of wire line connectivity include Firewire, and Universal Serial Bus 2.0. One embodiment contemplates universal connectivity between the station device 610 and portable computing device 620, and short-range wireless connectivity between the portable computing device 620 and the mobile environment device 630. Thus, for example, a user may use a standard wireless or wireline synchronization process to transfer contact records of library 612 and filter 614, while beaming select contact records from the portable computing device 620 to the mobile environment device 630 using Bluetooth or Infrared transport.

While FIG. 6 illustrates one usage scenario in which contact records are exchanged, numerous alternative usage scenarios exist for use with different embodiments of the invention. For example, the third computing device may be any type of computer, such as another desktop, and the filter 614 may serve purpose of protecting privacy, ensuring security or promoting convenience. For example, a user may use a mobile computing device with a home computer as the station device 610, and one or more remote stations or work stations instead of the mobile environment device 630. The user may designate certain data items as being secure, meaning they can be transferred from the home computer to the portable computing device 620, but not from the portable computing device to any other computer. This way, the filter 614 acts as a control in disabling the transfer of select data items.

If the user can ensure certain data items cannot be transferred off of the portable computing device 620, the user may encrypt such information using a password, and use a decryption key on the home station to automatically decode information. Alternatively, if certain folders cannot be transferred off the portable computing device but for transfer to the home station, the user can more readily ensure data protection in the event of a lost device using a “kill packet”. In short, the kill packet would wipe data off the portable computing device 620, and ensure the data could not be shared.

In another usage scenario, data items exchanged may correspond to play-lists of media files, including music and/or video files. The filter 614 may specify downstream play-lists, so that the filter implements a priority or sequence scheme on the third computing device. For example, portable computing device 620 may transfer music files with a very small form-factor storage and media player device with, for example, no visual user-interface. More specifically, the latter device's limited user-interface features hinder the user's ability to scroll from play-list to play-list. As an alternative, an embodiment enables the user to specify a desired play-list for the downstream limited device on a home computer, then transfer media files to the intermediate portable device, and then transport select media files from the intermediate portable device to the last device with desired play-list configurations specified on the home keyboard. This allows the user to use the keyboard or mouse of the home computer, rather than the user-interface features of the portable computing device to set the desired play-list.

Hardware Diagram

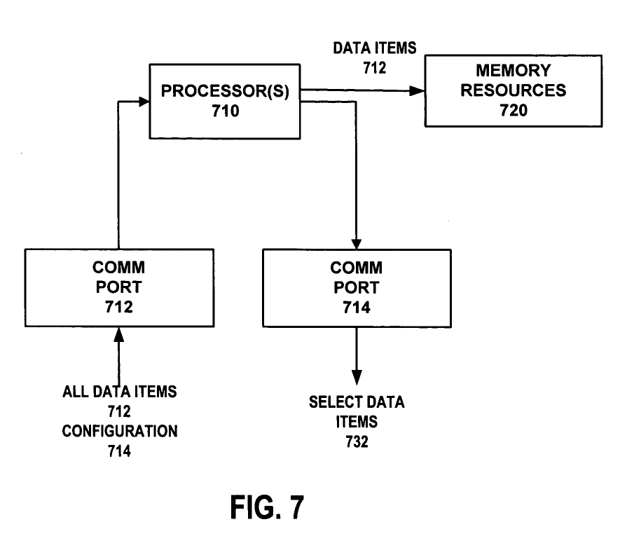

FIG. 7 is a basic block diagram of a computing device for handling data transfer configurations, for use in performing one or more embodiments of the invention. In FIG. 7, a portable computing device 700 is shown to represent the intermediate computing device of one or more embodiments described above. The portable computing device 700 may include one or more processors 710 and memory components 720, as well as other components not shown (e.g. speakers, display, microphone, battery, analog-digital converters etc.). The portable computing device 700 may communicate with another computer (e.g. desktop computer) in order to receive data items 712 for a collection of data items. The portable computing device 700 may also communicate with the other computing device to receive data transfer configurations 714 that affects how data items from the collection are subsequently communicated to another computing device.

As examples, the portable computing device 700 may correspond to a device with primary functionality corresponding to (i) cellular telephony and data transfer, (ii) personal information management, (iii) media playback (audio and/or video), and (iv) image and/or video capture. As described elsewhere, a typical usage scenario may correspond to the portable computing device 700 receiving data transfer configurations 714 from a computing device with more user-interface functionality than what the portable computing device 700 has, such as a desktop computer. Likewise, under one implementation the downstream device may correspond to one with limited memory or user-interface capabilities. While the aforementioned examples recite a specific usage example and devices for such usage, numerous other types of devices and usages are also contemplated.

In an embodiment, the portable computing device 700 receives data items 712 and stores the data items in the memory component 720. The data items 712 may be used with applications that execute by the processor 710. For example, a phone application, or a contact management application may use data items corresponding to data items when such applications are executed. To further an example, when the portable computing device corresponds to a cellular telephony device, the phone application may execute to present contact records and to enable contact records to have phone numbers displayed actively, so to enable phone connections from simple selection of data structures representing the phone numbers.

As described with one or more embodiments, the portable computing device 700 may be connected to another downstream device (not shown in this figure) to transfer some or all data items in the collection stored by memory 720. In one embodiment, the data transfer configuration 714 prioritizes or configures a protocol already existing on the computing device for transferring data items from the memory component 720. Thus, for example, the order or sequence in which data items are transferred may be altered, as compared to the normal order by which the data items would be transferred but for the data transfer configurations 714. Alternatively or in addition to an implementation as described, the association of the data items with respect to one another may be influenced. For example, if the data items were transferred to have a particular designated sequence or allotment (e.g. a play-list or a folder of data items), that sequence of allotment may be altered as a result of the data transfer configurations 714 when the data items are transferred downstream. Still further, as described with one or more embodiments, the data transfer configurations 714 may specify specific data items for transfer to the downstream device, to the exclusion of other items in the collection stored with memory component 720.

Alternative Embodiments

While embodiments such as described with FIG. 5 and elsewhere above provide for transfer configuration data to be selective or determinative of what data items are transferred, one or more embodiments provide that the transfer configuration data may specify a manner in which data items from a collection are to be transferred downstream (rather than which data items or priority), as well as how such data items are to be represented. For example, in the musical context, a user may specify a collection of media files, and designate that some of those media files are to be transferred to be provided in a particular order on the downstream device (e.g. third computing device) so as to form a play-list on that device.

Furthermore, while one or more embodiments described herein provide for data transfer configurations and filters to be implemented on a computing device that is sending data to another device, other embodiments contemplate that a computing device receiving data may implement the filter. For example, with reference to FIG. 6, the mobile environment device 630 may receive the data transfer configurations and implement the configurations as part of a receiving process.

Furthermore, while embodiments described herein recite use of three computing devices that directly communicate with one another, one or more embodiments may be performed in which only two computing devices are in direct communication with one another. For example, a portable memory (e.g. Secure Digital card or portable Flash memory) carrying data items from a collection may be provided to a recipient device (e.g. to the portable computing device 620 of FIG. 6). Data items on the portable memory may include data items provided from another computing source. The portable memory may also include data transfer configurations, and the portable computing device may read the data items and the configurations for subsequent downstream transfer.

Alternatively, the data transfer configurations may originate from another source, or even another computer. For example, in the immediately preceding example, the data transfer configurations may originate from another computer, or be derived from a source other than the portable memory. For example, data transfer configurations may originate from an email.

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

What is claimed is:

1. A method for exchanging data between computing devices, the method comprising:
identifying, on a first computing device, a data transfer configuration that is to be used in a subsequent data transfer between a second computing device and a third computing device, wherein the data transfer configuration is to cause selection of data items from a larger collection of data items that are to be exchanged in the subsequent data transfer; and
causing the data transfer configuration to be automatically implemented on the second computing device as a result of the first computing device communicating with the second computing device.

2. The method of claim 1, wherein the method further comprises transferring data from the first computing device to the second computing device in order to establish a collection of data items on the second computing device.

3. The method of claim 2, wherein identifying the data transfer configuration includes identifying a designated subset of records in the collection that are to be transferred from the second computing device to the third computing device to the exclusion of other records in the collection.

4. The method of claim 2, wherein identifying the data transfer configuration includes identifying a designated subset of records in the collection that is to be transferred before at least some other records in the collection.

5. The method of claim 1, wherein identifying the data transfer configuration includes identifying a sequence or a priority in which a designated subset of records in the collection is to be transferred.

6. The method of claim 2, wherein identifying the data transfer configuration includes identifying records that belong to a designated folder.

7. The method of claim 1, wherein causing the data transfer configuration to be automatically implemented on the second computing device includes performing a synchronization process between the first computing device and the second computing device.

8. The method of claim 1, wherein identifying the data transfer configuration includes specifying the data transfer configuration for at least one synchronization process between the second computing device and the third computing device.

9. The method of claim 1, further comprising receiving a user-input, and creating the data transfer configuration based on the user-input.

10. The method of claim 1, further comprising automatically implementing the data transfer configuration when the second computing device transfers data, including data items, to the third computing device.

11. The method of claim 1, wherein identifying a data transfer configuration includes identifying the data transfer configuration for use with any one or more of (i) sending data items from the second computing device to the third computing device during the subsequent session, (ii) receiving and then storing data items on the second computing device from the third computing device during the subsequent session, or (iii) synchronizing data items exchanged between the second computing device and the third computing device.

12. The method of claim 1, wherein identifying a data transfer configuration includes identifying one or more parameters that identifies a set of data items from the larger collection.

13. The method of claim 1, wherein identifying a data transfer configuration includes identifying a programmatic element that enables selection of the set of data items from the larger collection.

14. A method for exchanging data between computing devices, the method comprising:
communicating with a first computing device to (i) establish a collection of data items, and (ii) receive a data transfer configuration that is to be used for communicating with a second computing device; and
in response to initiating communications with a second computing device, performing a data transfer process that either (i) automatically selects data items from the collection of data items for transfer to the second computing device to the exclusion of other data items in the collection, or (ii) automatically prioritizes select data items from the collection of data items for transfer to the second computing device over other data items in the collection;
wherein performing the data transfer process includes using the data transfer configuration.

15. The method of claim 14, wherein performing a data transfer process that selects data items from the collection of data items includes (i)transferring data items from the set of data items to the second computing device during a unilateral data transfer process with the second computing device, or (ii) transferring data items from the set of data items during a bidirectional data transfer process with the second computing device.

16. The method of claim 14, wherein communicating with a first computing device is performed over one or more instances, so that data for establishing the collection of data items is received at a different instance from the data transfer configuration.

17. The method of claim 14, wherein the data items correspond to a data item selected from a group consisting of: (i) a contact record, (ii) a memorandum, (iii) a note, (iv) an audio file, (v) a digital picture, (vi) a video file, (vii) a document, and (viii) a calendar event.

18. The method of claim 14, wherein communicating with a first computing device includes performing a synchronization process with the first computing device.

19. The method of claim 18, wherein performing a data transfer process with the second computing device includes performing a unidirectional data transfer process.

20. A method for exchanging data items between computing devices, the method comprising:
receiving user-input that specifies a data transfer configuration on a first computing device;
communicating with a second computing device to establish a collection of data items on the second computing device;
receiving on the second computing device the data transfer configuration from the first computing device; and
communicating with a third computing device to establish a set of data items on the third computing device, wherein the set of data items are from the collection of data items, and wherein the data transfer configuration determines at least some of the data items in the set of data items.

21. The method of claim 20, wherein receiving on the second computing device the data transfer configuration is performed as part of communicating with the second computing device.

22. The method of claim 20, wherein communicating with the second computing device includes performing either (i) a synchronization operation to establish the collection of data items on the third computing device, or (ii) a unidirectional transfer to establish the collection of data items on the third computing device.

23. The method of claim 20, wherein communicating with a third computing device includes performing a synchronization operation to establish the set of data items on the third computing device

24. The method of claim 20, wherein communicating with the second computing device includes performing a unidirectional transfer of the set of data items from the second computing device to the third computing device.

25. The method of claim 20, wherein the data items in the collection include contact records.

26. A method for exchanging contact records between computing devices, the method comprising:
receiving user-input that specifies a data transfer configuration on a first computing device;
communicating with a second computing device to establish a collection of contact records on the second computing device;
receiving on the second computing device the data transfer configuration from the first computing device;
communicating with a third computing device to establish a set of contact records on the third computing device, wherein communicating with the third computing device includes implementing a protocol for selecting contact records to be transferred from the collection of contact records to the third computing device, and wherein implementing the protocol includes using the data transfer configuration to prioritize some contact records over other contact records.

27. The method of claim 26, wherein implementing a protocol for selecting contact records includes selecting for transfer contact records associated with speed-dial functions, and subsequently selecting for transfer contact records identified by the data transfer configuration.

28. The method of claim 27, wherein implementing a protocol for selecting contact records includes selecting for transfer contact records stored on a Subscriber Identification Module (SIM) of the second computing device.

29. A computer-readable medium carrying instructions for exchanging data between computing devices, the instructions including instruction, that when executed by one or more processes, cause the one or more processors to perform steps comprising:
communicating with a first computing device to (i) establish a collection of data items, and (ii) receive a data transfer configuration that is to be used for communicating with a second computing device; and
in response to initiating communications with a second computing device, performing a data transfer process that either (i) automatically selects data items from the collection of data items for transfer to the second computing device to the exclusion of other data items in the collection, or (ii) automatically prioritizes select data items from the collection of data items for transfer to the second computing device over other data items in the collection;
wherein performing the data transfer process includes using the data transfer configuration.

30. A portable computing device comprising:
one or more communication ports for communicating to a originating computing device and a
downstream computing device;
a memory configured to store data items; and
a processor configured to:
establish a collection of data items in the memory using data received from the originating computing device, and implement a data transfer configuration that is to be used for communicating with the downstream computing device;
uses the data transfer configuration to perform a data transfer process with the downstream device that either (i) automatically selects data items from the collection of data items for transfer to the downstream computing device to the exclusion of other data items in the collection, or (ii) automatically prioritizes select data items from the collection of data items for transfer to the downstream computing device over other data items in the collection.

31. The portable computing device of claim 30, wherein the collection of data items includes contact records.

32. The portable computing device of claim 30, wherein the data transfer configuration corresponds to data that indicates a specific folder assignment of select data items in the collection.
